(19) United States
(12) Patent Application Publication
(10) Pub. No.: US 2026/0171611 A1
(43) Pub. Date: Jun. 18, 2026

(54) ELECTRODE ASSEMBLIES, PREPARATION METHODS THEREOF AND RECHARGEABLE LITHIUM BATTERIES

(71) Applicant: SAMSUNG SDI CO., LTD., Yongin-si (KR)

(72) Inventors: Wanuk CHOI, Yongin-si (KR); Subong HONG, Yongin-si (KR); Sanghyuck AHN, Yongin-si (KR)

(73) Assignee: SAMSUNG SDI CO., LTD., Yongin-si (KR)

(21) Appl. No.: 19/417,659

(22) Filed: Dec. 12, 2025

(30) Foreign Application Priority Data
Dec. 16, 2024 (KR) 10-2024-0187522

(51) Int. Cl. H01M 50/474; H01M 4/525; H01M 10/052; H01M 10/0585; H01M 10/0587; H01M 50/486

(52) U.S. Cl. CPC H01M 50/474; H01M 4/525; H01M 10/052; H01M 10/0585; H01M 10/0587; H01M 50/486

(57) ABSTRACT

Disclosed are an electrode assembly and a rechargeable lithium battery including the same, the electrode assembly including an electrode group stack including a plurality of positive electrodes and one or more negative electrodes alternately stacked in a thickness direction with a separator interposed therebetween, wherein the plurality of positive electrodes includes a first positive electrode and a second positive electrode, the first positive electrode is disposed on the inner side of the electrode group stack, the second positive electrode is disposed on the outer side of the electrode group stack, the first positive electrode includes a first positive electrode current collector and a first positive electrode active material layer, the second positive electrode includes a second positive electrode current collector, a second positive electrode active material layer, and a resin layer, the resin layer is disposed at the outermost portion of the electrode group stack.

### CROSS-REFERENCE TO RELATED APPLICATION

This application claims priority to and the benefit of Korean Patent Application No. 10-2024-0187522 filed with the Korean Intellectual Property Office on Dec. 16, 2024, the entire contents of which are incorporated herein by reference.

### BACKGROUND

### 1. Field

Electrode assemblies, preparation methods thereof, and rechargeable lithium batteries are disclosed.

### 2. Description of the Related Art

Recently, with the rapid spread of electronic devices that use batteries, such as mobile phones, laptop computers, and electric vehicles, the demand for small, lightweight, and relatively high-capacity rechargeable batteries are rapidly increasing. In particular, rechargeable lithium batteries are attracting attention as a power source for portable devices because they are lightweight and have high energy density.

As high energy density of rechargeable lithium batteries becomes more important, high-capacity rechargeable lithium batteries are becoming more important. Therefore, to implement this, an electrode assembly including a stack having a high loading level is used.

Rechargeable lithium batteries include a positive electrode and a negative electrode including an active material capable of intercalating and deintercalating lithium ions, and an electrolyte solution, and electrical energy is produced through oxidation and reduction reactions when lithium ions are intercalated and deintercalated from the positive electrode and negative electrode.

The aforementioned information disclosed in the background technology of this invention is only intended to improve understanding of the background of the present disclosure and therefore may include information that does not constitute prior art.

### SUMMARY

Some example embodiments provide an electrode assembly capable of improving warpage phenomenon of a plate during a preparation process of the electrode assembly, thereby reducing a defect rate, and improving lifting phenomenon of the plate, and a rechargeable lithium battery including the same.

In some example embodiments, an electrode assembly includes an electrode group stack including a plurality of positive electrodes and one or more negative electrodes alternately stacked in a thickness direction with a separator interposed therebetween, wherein the plurality of positive electrodes includes a first positive electrode and a second positive electrode, the first positive electrode is disposed on the inner side of the electrode group stack, the second positive electrode is disposed on the outer side of the electrode group stack, the first positive electrode includes a first positive electrode current collector and a first positive electrode active material layer, the second positive electrode includes a second positive electrode current collector, a second positive electrode active material layer, and a resin layer, and the resin layer is disposed at the outermost portion of the electrode group stack.

In some example embodiments, a rechargeable lithium battery includes the aforementioned electrode assembly and an electrolyte between a plurality of positive electrodes and one or more negative electrodes of the electrode assembly, wherein the electrolyte is a liquid electrolyte or a solid electrolyte.

In some example embodiments, a method of preparing an electrode assembly includes providing a plurality of positive electrodes and one or more negative electrodes; and alternately stacking the plurality of positive electrodes and one or more negative electrodes in a thickness direction to prepare an electrode group stack; wherein the plurality of positive electrodes includes a first positive electrode and a second positive electrode, the first positive electrode is disposed on the inner side of the electrode group stack, the second positive electrode is disposed on the outer side of the electrode group stack, the first positive electrode includes a first positive electrode current collector and a first positive electrode active material layer, the second positive electrode includes a second positive electrode current collector, a second positive electrode active material layer, and a resin layer, and the resin layer is disposed at the outermost portion of the electrode group stack.

The electrode assembly according to some example embodiments and a rechargeable lithium battery including the same can improve cell reliability and safety by preventing warpage of the electrode plate and lifting of the electrode plate during the electrode assembly preparation process by coating a resin layer on the outermost surface of the electrode assembly stack.

### BRIEF DESCRIPTION OF THE DRAWINGS

FIG. 1 is a cross-sectional view of an electrode assembly according to some example embodiments.

FIG. 2 to FIG. 4 are schematic views of rechargeable lithium batteries according to some example embodiments.

FIG. 5 is a flow chart of a method of preparing an electrode assembly according to some example embodiments.

### DETAILED DESCRIPTION

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D₅₀) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or major axis length) of about 20 particles at random in a scanning electron microscope image.

Here, “or” is not to be construed as an exclusive meaning, for example, “A or B” is construed to include A, B, A+B, and the like.

“Metal” is interpreted as a concept including ordinary metals, transition metals and metalloids (semi-metals).

### Electrode Assembly

Some example embodiments provides an electrode assembly including an electrode group stack including a plurality of positive electrodes and one or more negative electrodes alternately stacked in a thickness direction with a separator interposed therebetween, wherein the plurality of positive electrodes includes a first positive electrode and a second positive electrode, the first positive electrode is disposed on the inner side of the electrode group stack, the second positive electrode is disposed on the outer side of the electrode group stack, the first positive electrode includes a first positive electrode current collector, and a first positive electrode active material layer, the second positive electrode includes a second positive electrode current collector, a second positive electrode active material layer, and a resin layer, and the resin layer is disposed at the outermost portion of the electrode group stack.

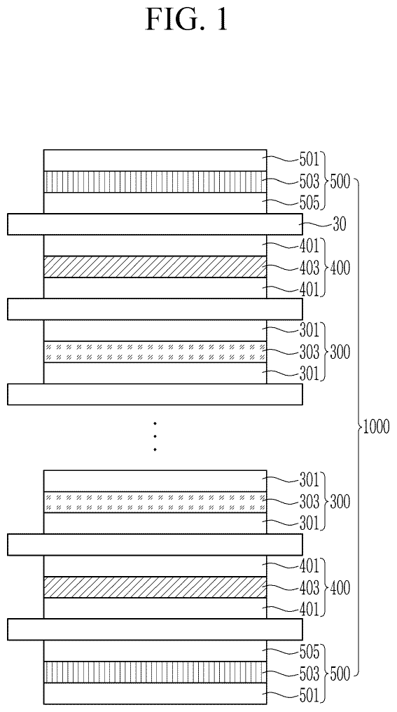

Hereinafter, an electrode assembly according to some example embodiments is described in detail with reference to FIG. 1.

FIG. 1 is a cross-sectional view of an electrode assembly according to some example embodiments.

Referring to FIG. 1, the electrode group stack 1000 includes a plurality of positive electrodes 300 and 500 and one or more negative electrodes 400 alternately stacked in the thickness direction with a separator 30 interposed therebetween, and the plurality of positive electrodes 300 and 500 include a first positive electrode 300 and a second positive electrode 500. The first positive electrode 300 is disposed on the inner side of the electrode group stack 1000, the second positive electrode 500 is disposed on the outer side of the electrode group stack 1000, the first positive electrode 300 includes a first positive electrode current collector 303 and a first positive electrode active material layer 301, and the first positive electrode active material layer 301 is disposed on both surfaces of the first positive electrode current collector 303. The second positive electrode 500 includes a second positive electrode current collector 503, a second positive electrode active material layer 505, and a resin layer 501, and the second positive electrode current collector 503 includes a first surface and a second surface. The first surface faces the inside, the second surface is the opposite surface of the first surface, the second positive electrode active material layer 505 is disposed on the first surface, and the resin layer 501 is disposed on the second surface. The negative electrode 400 includes a negative electrode current collector 403 and a negative electrode active material layer 401.

An electrode assembly including the electrode assembly stack can include a high loading amount of active material, thereby improving the energy density and performance of a rechargeable lithium battery. In the case of the second positive electrode disposed on the outer side of the electrode group stack, the positive electrode active material is coated on the single surface alone of the positive electrode current collector, and the phenomenon of the electrode plate warpage occurs due to asymmetry. Therefore, some example embodiments may improve the asymmetry of the electrode plates by coating a resin layer on the outermost portion of the second positive electrode located externally, thereby preventing the lifting phenomenon of the electrode plates. Hereinafter, the positive electrode is described in detail.

### Positive Electrode

The positive electrode includes a first positive electrode and a second positive electrode. The first positive electrode is disposed on the inner side of the electrode group stack, and the first positive electrode may include a first positive electrode current collector and a first positive electrode active material layer.

The second positive electrode is disposed on the outer side of the electrode group stack, and the second positive electrode may include a second positive electrode current collector, a second positive electrode active material layer, and a resin layer. Hereinafter, the resin layer and positive electrode active material layer included in the positive electrode are described in detail.

### Resin Layer

The resin layer may include a synthetic resin. The synthetic resin may be a thermosetting resin, a thermoplastic resin, or a combination thereof. A thickness of the resin layer may be about 5 μm to about 70 μm, about 10 μm to about 50 μm, or about 10 μm to about 40 μm. Alternatively, the resin layer may be about 0.05 to about 1.75 times, about 0.1 to about 1.5 times, about 0.1 to about 1 time, or about 0.1 to about 0.7 times the thickness of the second active material layer. When the above range is satisfied, the asymmetry of the positive electrode may be improved, thereby preventing the lifting phenomenon of the electrode.

Here, the thermosetting resin may include polyurethane (PU), an epoxy resin, a phenolic resin, polyimide, polyester, melamine, silicone, an amino resin, or a combination thereof or a combination of monomers constituting these.

The thermoplastic resin may include polyolefin such as polypropylene (PP), polyethylene (PE) or a combination thereof, and may include polyethylene terephthalate (PET), polyvinyl chloride (PVC), polystyrene (PS), acrylonitrile butadiene styrene (ABS), (meth)acrylic resin (e.g., polymethyl methacrylate (PMMA)), polyvinyl alcohol (PVA), polyvinylidene chloride (PVDC), polyamide (PA), polyoxymethylene (POM), polycarbonate (PC), polyphenylene ether (PPE), polybutylene terephthalate (PBT), polysulfone (PSU), polyethersulfone (PES), polyphenylene sulfide (PPS), an acrylic resin, nylon, or a combination thereof.

### Positive Electrode Active Material Layer

The positive electrode active material layer includes a first positive electrode active material layer and a second positive electrode active material layer. Here, the first positive electrode active material layer may include a first positive electrode active material, and the second positive electrode active material layer may include a second positive electrode active material. The first positive electrode active material and the second positive electrode active material may be the same or different from each other.

The positive electrode active material may be a compound (lithiated intercalation compound) capable of intercalating and deintercalating lithium. For example, one or more types of composite oxides of lithium and a metal selected from cobalt, manganese, nickel, and combinations thereof may be used.

The positive electrode active material may include lithium cobalt-based composite oxide, lithium nickel-based composite oxide, lithium nickel-cobalt-based composite oxide, lithium nickel-cobalt-aluminum-based composite oxide, lithium nickel-cobalt-manganese-based composite oxide, lithium nickel-manganese-based oxide, lithium manganese-based oxide, a lithium iron phosphate-based compound, or a combination thereof.

According to some example embodiments, a positive electrode active material may include a compound represented by Chemical Formula 11, which is a lithium cobalt-based oxide.

Liₐ₂Coₓ₂M³_{y2}O_{2-b2}X_{b2} [Chemical Formula 11]

In Chemical Formula 11, 0.9≤a2≤1.8, 0.7≤x2≤1, 0≤y2≤0.3, 0.9≤x2+y2≤1.1, 0≤b2≤0.1, M³ is Al, B, Ba, Ca, Ce, Cr, Cu, Fe, Mg, Mn, Mo, Ni, Se, Si, Sn, Sr, Ti, V, W, Y, Zn, Zr, or a combination thereof, and X is F, P, S, or a combination thereof.

In some example embodiments, the positive electrode active material may be a high-nickel positive electrode active material having a nickel content of greater than or equal to about 80 mol % based on 100 mol % of a metal excluding lithium in the lithium transition metal composite oxide. A nickel content in the high-nickel positive electrode active material may be greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium. The high-nickel positive electrode active material can achieve high capacity and can be applied to high-capacity, high-density rechargeable lithium batteries.

As a more specific example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<α<2); LiₐNi_{1-b-c}Mn_{b}X_{c}O_{2-α}D_{α} (0.90<a≤1.8, 0≤b≤0.5, 0≤c≤0.5, 0<α<2); LiₐNi_{b}CO_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8)

In the above chemical formulas, A is Ni, Co, Mn, or a combination thereof; X is Al, Ni, Co, Mn, Cr, Fe, Mg, Sr, V, a rare-earth element, or a combination thereof; D is O, F, S, P, or a combination thereof; G is Al, Cr, Mn, Fe, Mg, La, Ce, Sr, V, or a combination thereof; Q is Ti, Mo, Mn, or a combination thereof; Z is Cr, V, Fe, Sc, Y, or a combination thereof; and L¹ is Mn, Al or a combination thereof.

In the positive electrode active material layer, the binder serves to attach positive electrode active material particles well to each other and also to attach positive electrode active material well to adjacent layers. The binder may include for example, polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but is not limited thereto.

In the positive electrode active material layer, the conductive material is included to provide electrode conductivity and any electrically conductive material may be used as a conductive material unless it causes a chemical change. Examples of the conductive material may include a carbon-based material such as natural graphite, artificial graphite, carbon black, acetylene black, Ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

In the positive electrode active material layer, an amount of the positive electrode material may be about 90 wt % to 99 wt %, and each amount of the binder and the conductive material may be about 0.5 wt % to about 5 wt % based on 100 wt % of the positive electrode active material layer.

### Negative Electrode

The negative electrode may include a current collector; and a negative electrode active material layer on the current collector, and the negative electrode active material layer may include a negative electrode active material and may further include a binder, a conductive material, or a combination thereof.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite.

The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (wherein Q is an element selected from an alkali metal, an alkaline-earth metal, a Group 13 element, a Group 14 element (excluding Si), a Group 15 element, a Group 16 element, a transition metal, a rare earth element, and a combination thereof, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof), or a combination thereof. The Sn-based negative electrode active material may be Sn, SnO₂, a Sn alloy, or a combination thereof.

The silicon-carbon composite may be a composite of silicon and amorphous carbon. An average particle diameter (D₅₀) of the silicon-carbon composite particles may be, for example, about 0.5 μm to about 20 μm. According to some example embodiments, the silicon-carbon composite may be in the form of silicon particles and amorphous carbon coated on the surface of the silicon particles. For example, it may include a secondary particle (core) in which silicon primary particles are assembled and an amorphous carbon coating layer (shell) on the surface of the secondary particle. The amorphous carbon may also be present between the silicon primary particles, for example, the silicon primary particles may be coated with amorphous carbon. The secondary particles may exist dispersed in an amorphous carbon matrix.

The silicon-carbon composite may further include crystalline carbon. For example, the silicon-carbon composite may include a core including crystalline carbon and silicon particles and an amorphous carbon coating layer on the surface of the core. The crystalline carbon may be artificial graphite, natural graphite, or a combination thereof. The amorphous carbon may include soft carbon or hard carbon, a mesophase pitch carbonized product, and calcined coke.

When the silicon-carbon composite includes silicon and amorphous carbon, a silicon content may be about 10 wt % to about 50 wt % and an amount of amorphous carbon may be about 50 wt % to about 90 wt % based on 100 wt % of the silicon-carbon composite. In addition, when the composite includes silicon, amorphous carbon, and crystalline carbon, a silicon content may be about 10 wt % to about 50 wt %, an amount of crystalline carbon may be about 10 wt % to about 70 wt %, and an amount of amorphous carbon may be about 20 wt % to about 40 wt % based on 100 wt % of the silicon-carbon composite.

Additionally, a thickness of the amorphous carbon coating layer may be about 5 nm to about 100 nm. An average particle diameter (D₅₀) of the silicon particles (primary particles) may be about 10 nm to about 1 μm, or about 10 nm to about 200 nm. The silicon particles may exist as silicon alone, in the form of a silicon alloy, or in an oxidized form. The oxidized form of silicon may be represented by SiOₓ (0<x≤2). At this time, the atomic content ratio of Si:O, which indicates a degree of oxidation, may be about 99:1 to about 33:67. As used herein, when a definition is not otherwise provided, an average particle diameter (D₅₀) indicates a particle where an accumulated volume is about 50 volume % in a particle size distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and used, the mixing ratio may be a weight ratio of about 1:99 to about 90:10.

The binder serves to well adhere the negative electrode active material particles to each other and also to adhere the negative electrode active material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The dry binder may be a polymer material capable of becoming fiber, and may be, for example, polytetrafluoroethylene, polyvinylidene fluoride, a polyvinylidene fluoride-hexafluoropropylene copolymer, polyethylene oxide, or a combination thereof.

The conductive material is included to provide electrode conductivity and any electrically conductive material may be used as a conductive material unless it causes a chemical change. Examples of the conductive material include a carbon-based material such as natural graphite, artificial graphite, carbon black, acetylene black, Ketjen black, a carbon fiber, a carbon nanofiber, a carbon nanotube, and the like; a metal-based material of a metal powder or a metal fiber including copper, nickel, aluminum silver, and the like; a conductive polymer such as a polyphenylene derivative; or a mixture thereof.

An amount of the negative electrode active material may be about 95 wt % to about 99.5 wt % based on 100 wt % of the negative electrode active material layer, and an amount of the binder may be about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

The negative electrode current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be, for example, about 1 μm to about 20 μm, about 5 μm to about 15 μm, or about 7 μm to about 10 μm.

### Electrolyte

The electrolyte for a rechargeable lithium battery may be, for example, an electrolyte solution, which may include a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethyl acetate, methyl propionate, ethyl propionate, decanolide, mevalonolactone, valerolactone, caprolactone, and the like. The ether-based solvent may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (wherein R is a C2 to C20 linear, branched, or cyclic hydrocarbon group, a double bond, an aromatic ring, or an ether group, and the like; amides such as dimethylformamide; dioxolanes such as 1,3-dioxolane, 1,4-dioxolane, and the like; sulfolanes, and the like.

The non-aqueous organic solvent may be used alone or in combination of two or more, and when two or more types are used in combination, a mixing ratio can be appropriately adjusted depending on the intended battery performance, which is widely understood by those skilled in the relevant field.

When using a carbonate-based solvent, a cyclic carbonate and a chain carbonate may be mixed and used, and the cyclic carbonate and the chain carbonate may be mixed in a volume ratio of about 1:1 to about 1:9.

The non-aqueous organic solvent may further include an aromatic hydrocarbon-based organic solvent. For example, the carbonate solvent and the aromatic hydrocarbon organic solvent may be mixed and used in a volume ratio of about 1:1 to about 30:1.

The electrolyte solution may further include vinylethyl carbonate, vinylene carbonate or ethylene carbonate compounds to improve battery cycle-life.

Representative examples of the ethylene carbonate compound may include fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent supplies lithium ions in a battery, enables a basic operation of a rechargeable lithium battery, and improves transportation of the lithium ions between positive and negative electrodes.

Examples of the lithium salt may include at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂) (CyF_{2y+1}SO₂) (wherein x and y are integers of 1 to 20), lithium trifluoromethane sulfonate, lithium tetrafluoroethane sulfonate, lithium difluorobis(oxalato)phosphate (LiDFBOP), and lithium bis(oxalato) borate (LiBOB).

A concentration of lithium salt may be within the range of about 0.1 M to about 2.0 M. When the concentration of lithium salt is within the above range, the electrolyte solution has appropriate ionic conductivity and viscosity, and thus excellent performance can be achieved and lithium ions can move effectively.

### Separator

Depending on the type of the rechargeable lithium battery, a separator may be present between the positive electrode and the negative electrode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one polymer selected from polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. An average particle diameter (D₅₀) of the inorganic particles may be about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked.

A thickness of the coating layer may be about 0.5 μm to about 20 μm, for example, about 1 μm to about 10 μm, or about 1 μm to about 5 μm.

### Method of Preparing Electrode Assembly

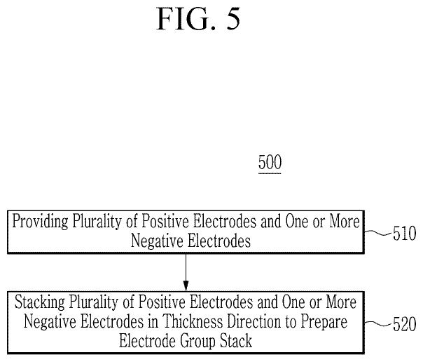

FIG. 5 is a flow chart of a method of preparing an electrode assembly according to some example embodiments.

In some example embodiments, referring to FIG. 5, a method (S500) of preparing an electrode assembly includes providing a plurality of positive electrodes and one or more negative electrodes (S510) and alternately stacking the plurality of positive electrodes and one or more negative electrodes in a thickness direction to prepare an electrode group stack (S520), wherein the plurality of positive electrodes includes a first positive electrode and a second positive electrode, the first positive electrode is disposed on the inner side of the electrode group stack, the second positive electrode is disposed on the outer side of the electrode group stack, the first positive electrode includes a first positive electrode current collector, and a first positive electrode active material layer, the second positive electrode includes a second positive electrode current collector, a second positive electrode active material layer, and a resin layer, and the resin layer is disposed at the outermost portion of the electrode group stack.

For example, in the method for manufacturing an electrode assembly, the first positive electrode active material layer may be disposed on both surfaces of the first positive electrode current collector, the second positive electrode current collector may include a first surface and a second surface, the first surface may face the inside, the second surface may be an opposite surface of the first surface, the second positive electrode active material layer may be disposed on the first surface, and the resin layer may be disposed on the second surface.

The above description relates to a method for preparing the electrode assembly according to some example embodiments, and hereinafter, descriptions overlapped with the above description regarding the electrode assembly will be omitted, and the method of preparing the electrode assembly according to some example embodiments will be described in detail.

The resin layer may be coated on the second surface of the second positive electrode current collector. At this time, after coating the resin layer on the second surface of the second positive electrode current collector, the plurality of positive electrodes and one or more negative electrodes may be alternately stacked in the thickness direction to prepare an electrode group stack, or after preparing an electrode group stack by alternately stacking a plurality of positive electrodes and one or more negative electrodes in the thickness direction, the resin layer may be coated on the second surface of the second positive electrode current collector.

At this time, the resin layer may be coated by spray coating, comma coating, die coating, gravure coating, or a combination thereof. The spray coating allows for a uniform coating by spraying resin into fine particles, and the comma coating allows for precise control of coating thickness through a blade. The die coating may achieve coating with precise thickness and width at high speed using a die and the gravure coating may achieve thin and uniform coating through an engraving roller. In the case of a coating method capable of coating a resin layer with a certain thickness, various coating methods may be used in addition to the coating method described above.

### Rechargeable Lithium Battery

In some example embodiments, a rechargeable lithium battery includes the aforementioned electrode assembly; and an electrolyte disposed between a plurality of positive electrodes and one or more negative electrodes included in the electrode assembly, wherein the electrolyte is a liquid electrolyte or a solid electrolyte.

Rechargeable lithium batteries can be classified into cylindrical, square, pouch, and coin types depending on their shape, with a pouch type being a representative example.

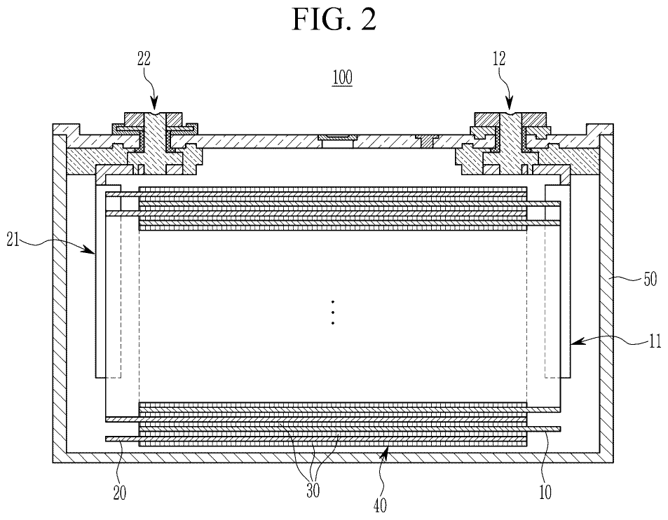

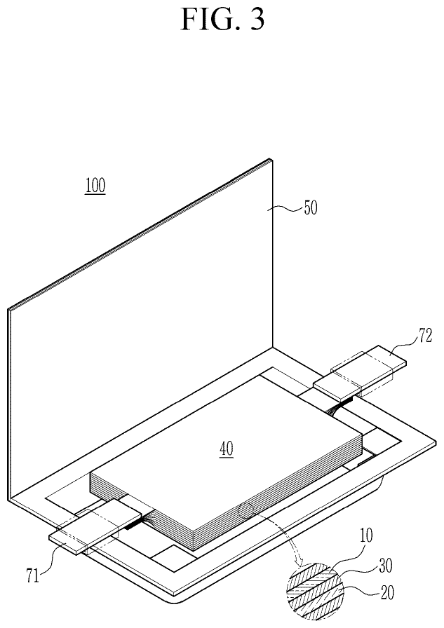

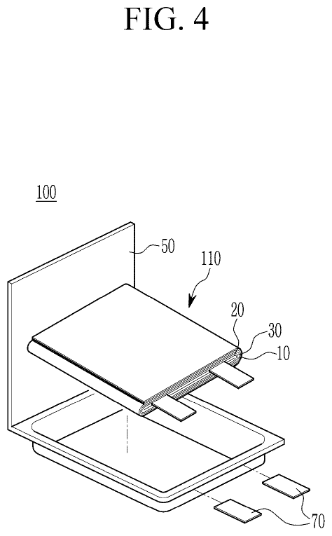

FIG. 2 to FIG. 4 are schematic views showing the rechargeable lithium battery according to some example embodiments, where FIG. 2 is a prismatic battery, and FIG. 3 and FIG. 4 are a pouch-shaped battery. Referring to FIG. 2 to FIG. 4, a rechargeable lithium battery 100 may include an electrode assembly 40 with a separator 30 interposed between a positive electrode 10 and a negative electrode 20, and a battery case 50 in which the electrode assembly 40 is housed. The positive electrode 10, negative electrode 20, and separator 30 may be impregnated with an electrolyte solution (not shown). In FIG. 2, the rechargeable lithium battery 100 may include a positive electrode lead tab 11, a positive electrode terminal 12, a negative electrode lead tab 21, and a negative electrode terminal 22. As shown in FIG. 3 and FIG. 4, a rechargeable lithium battery 100 may include an electrode tab 70, i.e., a positive electrode tab 71 and a negative electrode tab 72, which serve as electrical paths for conducting current formed in an electrode assembly 40 to the outside.

Examples and comparative examples of the present disclosure are described below. However, the following examples are only examples of the present disclosure, and the present disclosure is not limited to the following examples.

### Example 1

### (Manufacturing of First Positive Electrode)

LiCoO₂ (hereinafter, referred to as LCO) of a first positive electrode active material, carbon black (Denka Black) of a carbon conductive material, and polyvinylidene fluoride (PVdF) were mixed in a weight ratio of 96:1.8:2.2 and then, mixed with N-methylpyrrolidone (NMP) to prepare a slurry. The slurry was coated on both sides of an aluminum thin film with high strength and a thickness of 10 μm and then, dried at room temperature, dried again at 120° C. under vacuum, and compressed to manufacture a first positive electrode. Herein, a first positive electrode active material layer disposed on one surface of the first positive electrode current collector had a thickness of 70 μm.

### (Manufacturing of Second Positive Electrode)

LiCoO₂ (hereinafter, referred to as LCO) of a second positive electrode active material, carbon black (Denka Black) of a carbon conductive material, and polyvinylidene fluoride (PVdF) were mixed in a weight ratio of 96:1.8:2.2 and then, mixed with N-methylpyrrolidone (NMP) to prepare a slurry. The slurry was coated on one surface of an aluminum foil with a thickness of 25 μm, dried at room temperature, and dried again at 120° C. under vacuum to introduce a second positive electrode active material layer onto one surface of the second positive electrode current collector. In addition, on the other surface of the second positive electrode current collector, a polyimide resin was coated with a gravure coater, dried at room temperature, dried again at 120° C. under vacuum, and compressed to manufacture a second positive electrode onto which a resin layer was introduced. The second positive electrode active material layer disposed one surface of the second positive electrode current collector had a thickness of 70 μm, and the resin layer had a thickness of 10 μm.

### (Manufacturing of Negative Electrode)

A negative electrode active material slurry was prepared by mixing artificial graphite (BSG-L, Tianjin BTR New Energy Technology Co., Ltd.), a styrene-butadiene rubber (SBR) binder (ZEON Corp.), and carboxylmethyl cellulose (CMC, NIPPON A&L) in a weight ratio of 98:1:1, adding distilled water thereto, and mixing them with a mechanical stirrer for 60 minutes. The prepared slurry was coated to be about 60 μm thick on both sides of a 10 μm-thick copper foil with a die coater, dried in a hot air dryer at 100° C. for 0.5 hour, dried again at 120° C. under vacuum for 4 hours, and compressed to manufacture a negative electrode.

### (Manufacturing of Electrode Assembly Stack)

After alternately stacking the first positive electrode and the negative electrode, the second positive electrodes were placed respectively as the uppermost and lowermost layers to manufacture an electrode assembly stack. The electrode assembly stack had a structure of second positive electrode/negative electrode/first positive electrode/negative electrode/second positive electrode along the thickness direction. Between the first positive electrode and the negative electrode and between the second positive electrode and the negative electrode, polyethylene separators were respectively disposed.

### (Manufacturing of Pouch Cell)

The manufactured electrode assembly stack was inserted into an aluminum laminate bag, and after injecting an electrolyte prepared by dissolving 1.3 M LiPF₆ in a mixed solvent of EC (ethylene carbonate)+EMC (ethylmethyl carbonate)+DMC (dimethyl carbonate) (in a volume ratio of 3:4:3) thereinto, the bag was sealed, manufacturing a pouch cell.

### Example 2

A pouch cell was manufactured in the same manner as in Example 1 except that the second positive electrode active material layer was formed to have a thickness of 70 μm, and the resin layer was formed to have a thickness of 20 μm in the second positive electrode.

### Example 3

A pouch cell was manufactured in the same manner as in Example 1 except that the second positive electrode active material layer was formed to have a thickness of 70 μm, and the resin layer was formed to have a thickness of 30 μm in the second positive electrode.

### Example 4

A pouch cell was manufactured in the same manner as in Example 1 except that the second positive electrode active material layer was formed to have a thickness of 70 μm, and the resin layer was formed to have a thickness of 40 μm in the second positive electrode.

### Comparative Example 1

A pouch cell was manufactured in the same manner as in Example 1 except that the resin layer was not formed in the second positive electrode.

### Evaluation Example 1: Measurement of WarpageDegree and Defect Rate

The second positive electrodes according to Examples 1 to 3 and Comparative Example 1 were cut into a width of 4 cm and a length of 4 cm and then, placed on the flat surface to measure warped heights, which are shown in Table 1.

TABLE 1

| | Warpage degree (mm) |
|---|---|
| Example 1 | 5.3 |
| Example 2 | 2.1 |
| Example 3 | 1.8 |
| Example 4 | 1.0 |
| Comparative Example 1 | 8.2 |

Referring to Table 1, Examples 1 to 4, which included a resin layer on the outermost surface of each electrode assembly stack, exhibited an improved warpage degree, compared with Comparative Example 1.

### Evaluation Example 2: Safety Evaluation

Each of the cells according to Examples 1 to 3 and Comparative Example 1 was manufactured by 100, which were individually a total of 24 times dropped in each side direction from a height of 1.2 m to evaluate safety performance. Table 2 shows whether or not OCV decreased in the 24-time drop test. The OCV evaluation used criteria of a voltage difference of 50 mV or more before and after the dropping.

TABLE 2

| | The number of cells with a |
|---|---|
| | large change in OCV |
| | after dropping (ea/100) |
| Example 1 | 0 |
| Example 2 | 0 |
| Example 3 | 0 |
| Example 4 | 0 |
| Comparative Example 1 | 2 |

Referring to Table 2, Examples 1 to 4, which included a resin layer on the outermost surface of the electrode group stack, exhibited that the number of cells with a large change in OCV after the dropping was significantly reduced, compared to Comparative Example 1, which included no resin layer. The resin layer, which was present on the outermost surface of the electrode assembly stack, was confirmed to absorb an impact, improving safety of the cells.

### Evaluation Example 3: Defect Rate Evaluation

The cells according to Examples 1 to 3 and Comparative Example 1 were respectively manufactured by 100 to evaluate a defect rate. In the defect rate evaluation, it was evaluated as defective, if an electrode plate was neither smoothly inserted nor aligned during the assembly or there was lifting phenomenon between electrode plate and separator after the assembly due to the warpage of the electrode plate, thereby affecting electrical performance.

TABLE 3

| | Defect rate of electrode plate stack |
|---|---|
| | (ea/100) |
| Example 1 | 1 |
| Example 2 | 0 |
| Example 3 | 0 |
| Example 4 | 0 |
| Comparative Example 1 | 2 |

Referring to Table 3, Example 1 to 4, compared with Comparative Example 1, exhibited that the electrode plate defect rate was significantly improved. In the examples, the coated resin layer, which prevented warpages of the electrode plates, also was confirmed to improve the defect rate during the cell manufacturing. While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

<Description of Symbols>

| 1000: electrode assembly stack | 501: resin layer |
|---|---|
| 300: first positive electrode | 500: second positive electrode |
| 301: first positive electrode active material layer | |
| 303: first positive electrode current collector | |
| 503: second positive electrode current collector | |
| 505: second positive electrode active material layer | |
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. An electrode assembly, comprising
an electrode group stack comprising a plurality of positive electrodes and one or more negative electrodes alternately stacked in a thickness direction with a separator interposed therebetween,
the plurality of positive electrodes comprises a first positive electrode and a second positive electrode,
the first positive electrode is disposed on an inner side of the electrode group stack,
the second positive electrode is disposed on an outer side of the electrode group stack,
the first positive electrode comprises a first positive electrode current collector and a first positive electrode active material layer, and
the second positive electrode comprises a second positive electrode current collector, a second positive electrode active material layer, and a resin layer, and
the resin layer is disposed at the outermost portion of the electrode group stack.

2. The electrode assembly as claimed in claim 1, wherein
the first positive electrode active material layer is disposed on both surfaces of the first positive electrode current collector.

3. The electrode assembly as claimed in claim 1, wherein
the second positive electrode current collector has a first surface and a second surface,
the first surface faces the inside and the second surface is the opposite surface of the first surface, and
the second positive electrode active material layer is disposed on the first surface and the resin layer is disposed on the second surface.

4. The electrode assembly as claimed in claim 1, wherein
the resin layer comprises a thermosetting resin, a thermoplastic resin, or a combination thereof.

5. The electrode assembly as claimed in claim 4, wherein
the thermosetting resin comprises a polyester resin, a phenolic resin, a melanin resin, a silicone resin, an amino resin, an epoxy resin, polyurethane (PU), polyimide, or a combination thereof.

6. The electrode assembly as claimed in claim 4, wherein
the thermoplastic resin comprises a polyvinyl chloride resin, a polystyrene resin, a polyolefin resin, a (meth)acrylic resin, a nylon resin, or a combination thereof.

7. The electrode assembly as claimed in claim 1, wherein
a thickness of the resin layer is about 5 μm to about 70 μm.

8. The electrode assembly as claimed in claim 1, wherein
the first positive electrode active material layer and the second positive electrode active material layer each comprise a first positive electrode active material and a second positive electrode active material, and
the first positive electrode active material and the second positive electrode active material are the same or different from each other.

9. The electrode assembly as claimed in claim 8, wherein
the first positive electrode active material and the second positive electrode active material are each independently a lithium cobalt-based composite oxide, a lithium nickel-based composite oxide, a lithium nickel-cobalt-based composite oxide, a lithium nickel-cobalt-aluminum-based composite oxide, a lithium nickel-cobalt-manganese-based composite oxide, a lithium nickel-manganese-based oxide, a lithium manganese-based oxide, a lithium iron phosphate-based compound, or a combination thereof.

10. The electrode assembly as claimed in claim 8, wherein
the first positive electrode active material and the second positive electrode active material are each independently a lithium transition metal composite oxide represented by Chemical Formula 11: 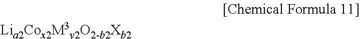
wherein, in Chemical Formula 11, 0.9≤a2≤1.8, 0.7≤x2≤1, 0≤y2≤0.3, 0.9≤x2+y2≤1.1, 0≤b2≤0.1, M³ is Al, B, Ba, Ca, Ce, Cr, Cu, Fe, Mg, Mn, Mo, Ni, Se, Si, Sn, Sr, Ti, V, W, Y, Zn, Zr, or a combination thereof, and X is F, P, and S, or a combination thereof.

11. The electrode assembly as claimed in claim 1, wherein
the first positive electrode active material layer and the second positive electrode active material layer further comprise at least one of a conductive material and a binder.

12. A rechargeable lithium battery, comprising
the electrode assembly as claimed in claim 1; and
an electrolyte that is each disposed between a plurality of positive electrodes and one or more negative electrodes of the electrode assembly,
wherein the electrolyte is a liquid electrolyte or a solid electrolyte.

13. A method of preparing an electrode assembly, comprising
providing a plurality of positive electrodes and one or more negative electrodes; and
alternately stacking the plurality of positive electrodes and one or more negative electrodes in a thickness direction to prepare an electrode group stack;
wherein the plurality of positive electrodes comprise a first positive electrode and a second positive electrode,
the first positive electrode is disposed on an inner side of the electrode group stack,
the second positive electrode is disposed on an outer side of the electrode group stack,
the first positive electrode comprises a first positive electrode current collector and a first positive electrode active material layer,
the second positive electrode includes a second positive electrode current collector, a second positive electrode active material layer, and a resin layer, and
the resin layer is disposed at the outermost portion of the electrode group stack.

14. The method as claimed in claim 13, wherein
the second positive electrode current collector has a first surface and a second surface,
the first surface faces the inside and the second surface is the opposite surface of the first surface, and
the second positive electrode active material layer is disposed on the first surface and the resin layer is disposed on the second surface.

15. The method as claimed in claim 14, wherein
the resin layer is coated on the second surface of the second positive electrode current collector.

16. The method as claimed in claim 15, wherein
the coating is spray coating, comma coating, die coating, gravure coating or a combination thereof.

17. The method as claimed in claim 15, wherein
after coating the resin layer on the second surface of the second positive electrode collector, the plurality of positive electrodes and one or more negative electrodes are alternately stacked in the thickness direction to prepare an electrode group stack.

18. The method as claimed in claim 15, wherein
after preparing an electrode group stack by alternately stacking the plurality of positive electrodes and one or more negative electrodes in the thickness direction, the resin layer is coated on the second surface of the second positive electrode current collector.
